(19) United States
(12) Patent Application Publication
(10) Pub. No.: US 2015/0289191 A1
(43) Pub. Date: Oct. 8, 2015

(54) DEVICE-TO-DEVICE COMMUNICATION METHOD, MODULE AND TERMINAL DEVICE

(71) Applicant: Huawei Technologies Co., Ltd., Shenzhen (CN)

(72) Inventors: Rui WANG, Shenzhen (CN); Sheng LIU, Shenzhen (CN); Rongdao YU, Shenzhen (CN); Yinggang DU, Shenzhen (CN)

(21) Appl. No.: 14/744,725

(22) Filed: Jun. 19, 2015

Related U.S. Application Data
(63) Continuation of application No. PCT/CN2013/090635, filed on Dec. 27, 2013.

(30) Foreign Application Priority Data
Dec. 31, 2012 (CN) 201210590564.6

(51) Int. Cl. H04W 40/02; H04W 8/00

(52) U.S. Cl. CPC H04W 40/02; H04W 8/005

(57) ABSTRACT

A device-to-device communication method, a device-to-device communication module and a terminal device are provided in embodiment of the present invention. A communication module is set in a first terminal device and includes: a routing support unit configured to generate an identification (ID) of a D2D communication module, discover a neighbor D2D communication module, and maintain routing information between the D2D communication module and the neighbor D2D communication module, where the neighbor D2D communication module is set in a second terminal device; and a point-to-point communication unit configured to communicate with the neighbor D2D communication module according to the ID of the D2D communication module and the routing information maintained by the routing support unit. The problem of achieving D2D communication between terminal devices can be resolved by adopting the technical solutions of the present invention.

### CROSS-REFERENCE TO RELATED APPLICATIONS

This application is a continuation of International Patent Application No. PCT/CN2013/090635, filed on Dec. 27, 2013, which claims priority to Chinese patent application No. 201210590564.6, filed on Dec. 31, 2012, both of which are hereby incorporated by reference in their entireties.

### TECHNICAL FIELD

The present invention relates to communications technologies and, in particular, to a device-to-device communication method, a module and a terminal device.

### BACKGROUND

In conventional cellular communication, air interface has only two types of communication modes, that is, an uplink transmission from a terminal device to a base station and a downlink transmission from a base station to a terminal device. With the development of terminal devices, communication abilities are gradually developed between terminal devices, for example, a terminal device using bluetooth or WiFi can directly transfer data with another terminal device. The mode of a direct communication between terminal devices is known as device-to-device (hereinafter referred to as D2D) communication.

In fact, the D2D communication between the terminal device has been used not only in sharing data that generated by terminal device at local site, but also used in assisting terminal devices to acquire data from the network and share those network data, which is beneficial to reduce the cellular network load and user internet surfing cost. For example, a first and a second terminal devices, which are near to each other, try to download the same content from the internet, they can negotiate with each other and then each of them download only half of the required content, and then the downloaded content is exchanged between them through D2D communication, therefore the first and the second terminal devices obtain the required content, meanwhile user internet surfing cost and cellular network burden are reduced. Prior art provides only a solution to a joint transmission conducted by D2D and cellular communication, but without giving a solution of how to achieve a D2D communication between terminal devices.

### SUMMARY

Embodiments of the present invention provide a device-to-device communication method, a module and a terminal device to resolve the problem of achieving D2D communication between terminal devices.

A first aspect provides a device-to-device (D2D) communication module, which is set in a first terminal device, and the D2D communication module includes:
a routing support unit, configured to generate an identification (ID) of the D2D communication module, discover a neighbor D2D communication module, and maintain routing information between the D2D communication module and the neighbor D2D communication module, where the neighbor D2D communication module is set in the second terminal device; and
a point-to-point communication unit, configured to communicate with the neighbor D2D communication module according to the ID of the D2D communication module and the routing information.

A second aspect provides a device-to-device (D2D) communication method, where the method includes:
generating, by a D2D communication module set in a first terminal device, an identification (ID) of the D2D communication module; discovering a neighbor D2D communication module; and maintaining routing information between the D2D communication module and the neighbor D2D communication module, where the neighbor D2D communication module is set in a second terminal device; and
communicating, by the D2D communication module, with the neighbor D2D communication module according to the ID of the D2D communication module and the routing information of the D2D communication module.

A third aspect provides a terminal device, which includes any one of the device-to-device (D2D) communication module provided in the first aspect and at least one D2D air interface; where the D2D communication module communicates with a neighbor D2D communication module via the at least one D2D air interface.

Embodiments of the present invention provide the device-to-device communication method, the device-to-device communication module and the terminal device. Each terminal device is set with the D2D communication module. Specifically, each D2D communication module generates the ID of the D2D communication module through its own routing support unit, discovers the neighbor D2D communication module and maintains routing information with neighbor D2D communication module, and a point-to-point communication unit performs the communication with the neighbor D2D communication module according to the ID of the D2D communication module itself and the routing information maintained by the routing support unit, thereby achieving D2D communication between terminal devices.

### BRIEF DESCRIPTION OF DRAWINGS

In order to clearly illustrate the technical solutions in embodiments of the present invention or in prior art, the drawings described in the embodiments are briefly introduced as followed. It is obvious that the drawings described as followed are merely some embodiments of the present invention, for those skilled in the art, without doing any creative work, other drawings can be obtained according to the following drawings.

FIG. 1 is a schematic structural diagram of a D2D communication module according to an embodiment of the present invention;

FIG. 2 is a schematic structural diagram of a D2D communication module according to another embodiment of the present invention;

FIG. 3 is a schematic diagram of an implementation structure of a terminal device according to an embodiment of the present invention;

FIG. 4 is a schematic structural diagram of a D2D communication module according to still another embodiment of the present invention; and

FIG. 5 is a flowchart of a D2D communication method according to an embodiment of the present invention.

### DESCRIPTION OF EMBODIMENTS

To make the objective, technical solutions and advantages of embodiments of the present invention more clearly, the technical solutions of embodiments of the present invention are hereinafter described in detail and completely with reference to the drawings of embodiments of the present invention. It is obvious that the described embodiments are merely partial embodiments of the present invention, rather than all embodiments. Based on the embodiments of the present invention, any other embodiments obtained by those skilled in the art without doing any creative work are all within the protection scope of the present invention.

To resolve the problem of achieving a D2D communication between terminal devices, embodiments of the present invention provide technical solutions. In the technical solutions, each terminal device is set with a D2D communication module, where the D2D communication module is responsible for achieving the D2D communication between the terminal devices. The D2D communication module set in any one of the terminal devices has the same function. For describing conveniently, the following embodiments of the present invention will be described by taking a D2D communication module set in a first terminal device as an example, and a D2D communication module, set in other terminal devices that can act as the neighbor of the first terminal device, is called a neighbor D2D communication module; and the terminal device, where the neighbor D2D communication module is located, is called a second terminal device. It should be noted here that the number of the neighbor D2D communication module and that of the second terminal device are the same, and the number may be one and may also be more than one.

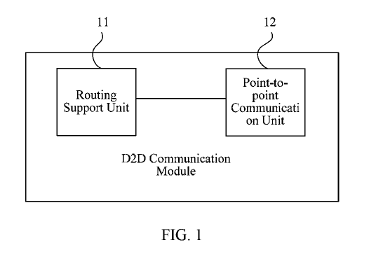

FIG. 1 is a schematic structural diagram of a D2D communication module according to an embodiment of the present invention. The D2D communication module in this embodiment is set in a first terminal device, as shown in FIG. 1, the D2D communication module in this embodiment includes: a routing support unit 11 and a point-to-point communication unit 12.

The routing support unit 11 is configured to generate an identification (ID) of the D2D communication module in this embodiment, discover a neighbor D2D communication module, and maintain routing information between the D2D communication module and the neighbor D2D communication module in this embodiment. In this embodiment, the neighbor D2D communication module is set in a second terminal device.

The point-to-point communication unit 12 is configured to communicate with the neighbor D2D communication module according to the ID of the D2D communication module in this embodiment and the routing information between the D2D communication module in this embodiment and the neighbor D2D communication module maintained by the routing support unit 11.

In this embodiment, the first and the second terminal devices have a D2D communication ability, meanwhile, in addition to the D2D communication ability, have other communication abilities such as a cellular communication ability, so as to strengthen the advantages of a joint transmission by using the D2D communication ability and other communication abilities (e.g. a cellular communication ability). Each terminal device having a D2D communication ability all need to communicate with as many other terminal devices having D2D communication ability as possible, so as to increase the possibility of conducting the joint transmission.

Based on the above, the routing support unit 11 in this embodiment will drive an air interface of the D2D communication module to discover the nearby second terminal devices as many as possible, for maintaining more routing information between the D2D communication module in this embodiment and the neighbor D2D communication module. In this embodiment, the air interface of the D2D communication module is called a D2D air interface. This embodiment does not limit the implementation of the D2D air interface, for example the D2D air interface may be but not be limited to: WiFi Direct, bluetooth, or in-band D2D communication air interface of future cellular communication and so on.

For different D2D air interfaces, the routing support unit 11 may maintain routing information with the neighbor D2D communication module in different manners A WiFi Direct air interface will be taken as an example in the following for describing how the routing support unit 11 maintains the routing information between the D2D communication module in this embodiment and the neighbor D2D communication module. Specifically, the WiFi Direct air interfaces, before conducting the communication between terminal devices, firstly forms several groups (Group), and each Group has a group owner (Group Owner) who servers a function that is similar to that of an access point (hereinafter referred to as AP). Within each Group, each terminal device can directly communicate with each other. Based on the characteristics of the WiFi Direct air interface, the routing support unit 11 in this embodiment needs to drive the first terminal device to join more Groups where the second terminal device is located, and drives a data transfer performed by terminal devices across different Groups, so that a single hop or a multiple hops communication can be conducted via a WiFi Direct protocol.

For example, a specific implementation of driving the first terminal device to join more Groups where the second terminal device is located by the routing support unit 11 includes: the routing support unit 11 in the first terminal device searches for Groups around via the WiFi Direct air interface. If there are formed Groups around, the routing support unit 11 drives the first terminal device to try to join these Groups. After joining these Groups, the routing support unit 11 try to discover whether the Group Owners in these Groups have a D2D communication module, if the Group Owners have the D2D communication module, then the terminal devices in these Groups are taken as the second terminal devices, and the D2D communication modules in these terminal devices are the neighbor D2D communication modules of the D2D communication module in this embodiment. Alternatively, the routing support unit 11 may maintain a neighboring relationship between the D2D communication module in this embodiment and the neighbor D2D communication module by broadcasting a neighbor list. When a neighbor D2D communication module is discovered, the routing support unit 11 updates the neighbor list, i.e., the information of the newly discovered D2D communication module is added to the neighbor list. If there is no Group around, or the routing support unit 11 cannot drive the first terminal device to join the formed Group, or it is discovered that there are other terminal devices which may have the D2D communication module but still does not join the formed Group around, then the routing support unit 11 drives the first terminal device to form a Group by itself, and act as the Group Owner, when a new terminal device joins, the routing support unit 11 tries to discover whether there is a D2D communication module running in the new terminal device, if there is a D2D communication module in the new terminal device, the new terminal device is taken as the second terminal device, and the D2D communication module in the new terminal device is the neighbor D2D communication module of the D2D communication module in this embodiment, there may be one or multiple second terminal devices. As such, the D2D communication modules of different terminal devices constitute an Ad Hoc network, in this case the routing support unit 11 can establish a routing table of the neighbor D2D communication module by using various existing algorithms of the Ad Hoc network. In the routing table, for a single hop neighbor D2D communication module, the maintained routing information includes an ID of the single hop neighbor D2D communication module and a D2D air interface which is used by the D2D communication module in this embodiment for reaching the neighbor D2D communication module; for a multiple hops neighbor D2D communication module, the maintained routing information includes an ID of the multiple hops neighbor D2D communication module, an ID of a next hop neighbor D2D communication module and a D2D air interface used by the next hop neighbor D2D communication module.

Though the above method, the routing support unit 11 can not only maintain routing information between the D2D communication module in this embodiment and the neighbor D2D communication module but also drive the D2D communication module in this embodiment to discover more neighbor D2D communication modules.

In addition, since this embodiment support several types of D2D air interfaces, when an application program on the first terminal device calls a D2D air interface via the point-to-point communication unit (e.g. receiving or transmitting network data via the D2D air interface), the point-to-point communication unit 12 will encapsulate discrepancies between D2D air interfaces for the application program invoking the D2D air interface, that is, the application program does not need to concern about details of using D2D air interface, and those details are responsible by the point-to-point communication unit 12.

In this embodiment, the D2D communication module in each terminal device owns an ID, so that the D2D communication module is uniquely identified. The ID of the D2D communication module may be generated by the routing support unit 11 according to the medium access control (hereinafter referred to as MAC) address of the terminal device in which the D2D communication module is located, to ensure that a circumstance that D2D communication modules in different terminal devices have the same ID will never happen. In addition, the ID of the D2D communication module is also maintained by the routing support unit 11.

The point-to-point communication unit 12 may achieve the communication between the D2D communication module in this embodiment and the neighbor D2D communication module through the following method: similar to transmission control protocol (hereinafter referred to as TCP) and user datagram protocol (hereinafter referred to as UDP) services, the point-to-point communication unit 12 may provide two types of communication links between one process of the first terminal device and one process of the second terminal device: a connection-oriented communication link (similar to TCP) and a connectionless-oriented communication link (similar to UDP). Likewise, similar to the TCP or UDP protocol, the point-to-point communication unit 12 allocates port to the application program using the point-to-point communication unit 12 to transmit or receive data. A data transmitting end or receiving end on the first terminal device may be uniquely identified by using the ID of the D2D communication module in this embodiment and the port number of the corresponding application program. When the application program transmits data in the connectionless-oriented communication mode, the point-to-point communication unit 12 in the D2D communication module at the transmitting end does not need to notify the point-to-point communication unit 12 in the D2D communication module at the receiving end in advance, but can directly transmit the data to the point-to-point communication unit 12 in the D2D communication module at the receiving end. When the application program transmits data in the connection-oriented communication mode, the point-to-point communication unit 12 in the D2D communication module at the transmitting end needs to notify the point-to-point communication unit 12 in D2D communication module at the receiving end in advance, and establish a connection from the ID of the D2D communication module at the transmitting end and the port of the application program at the transmitting end to the ID of the D2D communication module at the receiving end and the port of the application program at the receiving end, after that, the port of the above application program at the receiving end will only receive data transmitted from the port of the above application program at the transmitting end.

When using the connection-oriented communication mode, the point-to-point communication unit 12 in the D2D communication module at the transmitting end needs to guarantee a reliable and ordered data transmission, based on this, the point-to-point communication unit 12 in the D2D communication module at the transmitting end segments the data to be transmitted according to a fixed size, and each segment is packaged using a data packet, where the data packet includes at least the following information: the ID of the D2D communication module at the transmitting end and the port number of the application program at the transmitting end, the ID of the D2D communication module at the receiving end and the port number of the application program at the receiving end, and a sequence number of the data packet, where the sequence number is used for sorting the data packet by the point-to-point communication unit 12 at the receiving end. Correspondingly, the point-to-point communication unit 12 in the D2D communication module at the receiving end needs to acknowledge a reception of the data packet transmitted by the point-to-point communication unit 12 in the D2D communication module at the transmitting end. The algorithms for acknowledging a transmission and a reception may refer to a sliding window protocol of TCP, and will not be repeated here.

Based on the above communication modes, a case of the point-to-point communication unit 12 configured to communicate with the neighbor D2D communication module according to the ID of the D2D communication module in this embodiment and the routing information between the D2D communication module in this embodiment and the neighbor D2D communication module maintained by the routing support unit 11 includes:

The point-to-point communication unit 12 is specifically configured to receive first network data provided by the first terminal device, and transmit the first network data to the neighbor D2D communication module according to the ID of the D2D communication module in this embodiment and the routing information maintained by the routing support unit 11.

Further, the point-to-point communication unit 12 is specifically configured to receive the first network data provided by a first application program on the first terminal device, allocate a first port to the first application program, package the first network data to obtain a data packet according to the ID of the D2D communication module in this embodiment, the port number of the first port, the ID of the neighbor D2D communication module and a port number of a second port allocated to a second application program by the neighbor D2D communication module, and transmit the packaged data packet to the neighbor D2D communication module through the routing information maintained by the routing support unit 11, where the second application program is an application program which is on the second terminal device, in which the neighbor D2D communication module is located, and communicates with the first application program. It should be noted that, the application programs on the two terminal devices achieves the D2D communication with each other by calling the D2D communication module in the terminal device in which the corresponding application program is located.

Alternatively, the first network data provided by the first application program may be directly downloaded from a network server by the first application program. Based on this, the point-to-point communication unit 12 may specifically be configured to receive the first network data directly downloaded from the network server by the first application program on the first terminal device.

Alternatively, a case of the point-to-point communication unit 12 configured to communicate with the neighbor D2D communication module according to the ID of the D2D communication module in this embodiment and the routing information between the D2D communication module in this embodiment and the neighbor D2D communication module maintained by the routing support unit 11 includes:

The point-to-point communication unit 12 is specifically configured to receive the second network data transmitted by the neighbor D2D communication module according to the ID of the D2D communication module in this embodiment and the routing information maintained by the routing support unit 11. The second network data transmitted by the neighbor D2D communication module may be transmitted by the second application program on the second terminal device in which the neighbor D2D communication module is located via the neighbor D2D communication module.

It can be seen that, in this embodiment, each terminal device is set with a D2D communication module. Specifically, each D2D communication module generates the ID of the D2D communication module through its own routing support unit, discovers the neighbor D2D communication module and maintains routing information with neighbor D2D communication module, and a point-to-point communication unit performs the communication with the neighbor D2D communication module according to the ID of the D2D communication module itself and the routing information maintained by the routing support unit, thereby achieving D2D communication between terminal devices. Further, according to the D2D communication module in this embodiment, data sharing can be realized among terminal devices, if a joint transmission is performed with cellular communication, the burden of the cellular communication is greatly reduced, and cost of users experience and internet surfing will also be greatly reduced. In addition, it is only need to deploy a D2D communication module in this embodiment in a terminal device without modifying an existing wireless communication system, which is easy to achieve and have a relative lower deployment cost.

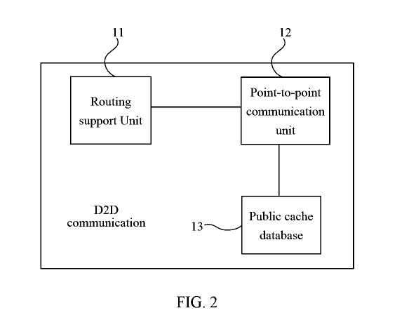

FIG. 2 is a schematic structural diagram of a D2D communication module according to another embodiment of the present invention. This embodiment is achieved based on the embodiment shown in FIG. 1. As can be seen from FIG. 2, the D2D communication module in this embodiment also includes: a public cache database 13.

The public cache database 13 is configured to receive the first network data provided by the first terminal device and store data. It should be noted that, the public cache database 13 may store network data transmitted by each application program on the first terminal device, this embodiment is described by taking the first application program on the first terminal device as an example, then the public cache database 13 is specifically configured to receive the first network data transmitted by the first application program on the first terminal device and store data. While the first application program submits the first network data to the public cache database 13, the first application program also needs to submit identification information of the first network data to the public cache database 13. The identification information of the first network data may be but not be limited to the network address of the first network data, for uniquely identifying the first network data. For example: if the first network data is a file downloaded from a certain website, then the identification information of the first network data is a specific address of the file on the internet. For example, the identification information of the first network data may also be the name of the first network data.

Alternatively, while the first application program submits the first network data to the public cache database 13, the first application program may also submit a period of validity of the first network data to the public cache database 13, so that the public cache database 13 can delete the first network data after the period of validity is expired, which is beneficial for improving the use efficiency of the public cache database 13.

The public cache database 13 in this embodiment may also be configured to provide stored network data to the application program on the first terminal device or the second terminal device. In this embodiment, the point-to-point communication unit 12 will allocate a port to the public cache database 13, so as to enable the public cache database 13 to provide the stored network data to the application program on the first terminal device or the second terminal device. To distinguish the ports used in each embodiment of the present invention easily, the port allocated to the public cache database 13 by the point-to-point communication unit 12 is recorded as the fourth port.

Taking a first application program on the first terminal device requesting a third network data from the public cache database 13 as an example, the public cache database 13 is also configured to receive a first query request for querying for the third network data transmitted by the first application program, perform a query according to the first query request and return a first query result to the first application program, where the first query request includes identification information of the third network data.

It should be noted that, when the first application program queries the local public cache database 13, the first query request transmitted by the first application program may carry an ID of the D2D communication module at the transmitting end (the ID of the D2D communication module at the transmitting end herein is the ID of the D2D communication module in this embodiment), the port number of the first port allocated to the first application program by the point-to-point communication unit 12, an ID of the D2D communication module at the receiving end (the ID of the D2D communication module at the receiving end herein is also the ID of the D2D communication module in this embodiment), and a port number of a four port allocated to the public cache database 13 by the point-to-point communication unit 12, and may also do not carry these IDs and port number information.

Further, the public cache database 13 is also configured to maintain a neighbor index table, where the neighbor index table stores identification information of network data stored in the neighbor D2D communication module. That is to say, the public cache database 13 in each D2D communication module can exchange identification information of the stored network data in the form of the neighbor index table, thus, the application program can not only query the network data stored in the local public cache database 13, but also query information of network data stored in a remote public cache database 13 at home.

Based on the above, the public cache database 13 is specifically configured to receive the first query request for querying for the third network data transmitted by the first application program, perform a local query according to the identification information of the third network data, if the third network data is obtained through the local query, take the third network data as the first query result and return to the first application program; and if the third network data is not obtained through the local query, query the maintained neighbor index table according to the identification information of the third network data, if there is a neighbor index table including the identification information of the third network data, take the ID of a first neighbor D2D communication module, which corresponds to the neighbor index table including the identification information of the third network data, as the first result and return to the first application program. In this embodiment, for describing conveniently, a neighbor D2D communication module, which corresponds to the neighbor index table including the identification information of the third network data, is called the first neighbor D2D communication module. The first neighbor D2D communication module is one of the neighbor D2D communication modules of the D2D communication module in this embodiment.

Based on the above, still another case of the point-to-point communication unit 12 configured to communicate with the neighbor D2D communication module according to the ID of the D2D communication module in this embodiment and the routing information between of the D2D communication module in this embodiment and the neighbor communication module maintained by the routing support unit 11 includes:

The point-to-point communication unit 12 is specifically configured to receive a second query request transmitted by the first application program, transmit the second query request to the first neighbor D2D communication module according to the ID of the D2D communication module in this embodiment and the routing information maintained by the routing support unit 11, and receive a second query result returned by the first neighbor D2D communication module according to the second query request, and then return the second query result to the first application program. The second query request is generated by the first application program according to the ID of the first neighbor D2D communication module when the first query result is the ID of the first neighbor D2D communication module. The second query request includes the ID of the D2D communication module in this embodiment, the port number of the first port allocated to the first application program by the point-to-point communication unit 12 in the D2D communication module in this embodiment, the ID of the first neighbor D2D communication module, the port number of the third port allocated to the public cache database of the first neighbor D2D communication module by the point-to-point communication unit 12 of the first neighbor D2D communication module, and the identification information of the third network data.

Based on the public cache database 13, still another case of the point-to-point communication unit 12 configured to communicate with the neighbor D2D communication module according to the ID of the D2D communication module in this embodiment and the routing information between the D2D communication module in this embodiment and the neighbor D2D communication module maintained by the routing support unit 11 includes:

The point-to-point communication unit 12 is specifically configured to receive a third query request transmitted by the neighbor D2D communication module and return a third query result to the neighbor D2D communication module according to the ID of the D2D communication module in this embodiment and the routing information maintained by the routing support unit 11. The third query request includes the ID of the D2D communication module in this embodiment, a port number of a fourth port allocated to the public cache database 13 of the D2D communication module in this embodiment by the point-to-point communication unit 12 in the D2D communication module in this embodiment, the ID of the neighbor D2D communication module, a port number of a fifth port allocated to a third application program on the second terminal device by the point-to-point communication unit 12 of the neighbor D2D communication module, and identification information of the fourth network data which is requested to be queried for by the third application program.

Accordingly, the public cache database 13 is also configured to receive the third query request transmitted by the point-to-point communication unit 12, perform a local query according to the third query request, and return a third query result to the point-to-point communication unit 12. The third query result herein may be the fourth network data obtained through query, or a result indicating query failed.

Alternatively, to facilitate performing a query by a local or a remote application program, the public cache database 13 may monitor a query request on the fourth port allocated by the point-to-point communication unit 12 so as to return a query result to each application program on time. The port number of the fourth port used by the public cache database 13 is known to all application programs.

As can be seen from above, the public cache database in this embodiment may be queried by the application program on the local first terminal device, and return a query result, in addition, may also receive a query result transmitted by an application program on the second terminal device via the point-to-point communication unit of the second terminal device, and support a remote query, thereby allowing the coordination between terminal devices. Besides, since the D2D communication module in this embodiment provides the public cache database storing network data, different application programs on the same or different terminal devices can share network data, these different application programs do not need to have the ability to directly communicate with each other, and they share network data through the public cache database, in this case, sharing data is no longer limited to between the same application programs.

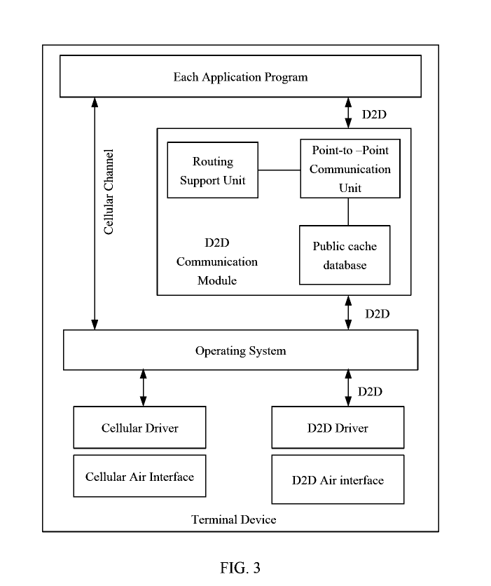

Based on the D2D communication module in this embodiment, FIG. 3 shows a schematic diagram of an implementation structure of a terminal device simultaneously having a cellular communication ability and a D2D communication ability. As shown in FIG. 3, the terminal device includes: each application program, a D2D communication module, a cellular channel, an operating system, a cellular driver, a cellular air interface, a D2D driver and a D2D air interface. The hierarchical relationship among the above elements is shown in FIG. 3, which will not be repeated here in detail.

Embodiments of the present invention provides a terminal device, including a D2D communication module provided in the above embodiments and at least one D2D air interface; where, the D2D communication module communicates with a neighbor D2D communication module via the at least one D2D air interface. Specifically, the D2D communication module may manage simultaneously at least one D2D air interface, and operations to these D2D air interface performed by an upper level application program is irrelevant to a specific air interface, the D2D communication module can masking the discrepancies between the D2D air interfaces, please refer to the description in the above embodiments for detail.

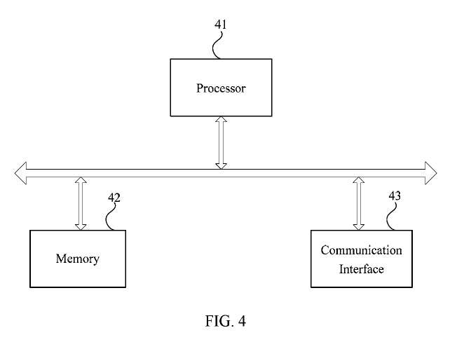

FIG. 4 is a schematic structural diagram of a D2D communication module according to another embodiment of the present invention. The D2D communication module in this embodiment is set in a first terminal device, as described in FIG. 4, the D2D communication module in this embodiment includes: a processors 41, a memory 42 and a communication interface 43.

The memory 42 is configured to store a program. Specifically, the program may include program code, and the program code includes a computer operating instruction. The memory 42 may include a high speed RAM memory, and may also include a non-volatile memory such as at least one disk memory.

The processor 41 is configured to execute the program stored in the memory 42, in order to: generate an identification ID of the D2D communication module in this embodiment, discover a neighbor D2D communication module, and maintain routing information between the D2D communication module in this embodiment and the neighbor D2D communication module. In this embodiment, the neighbor D2D communication module is set in a second terminal device.

The processor 41 may be a central processor unit (hereinafter referred to as CPU), or an application specific integrated circuit (hereinafter referred to as ASIC), or configured to be one or a plurality of integrated circuit implementing embodiments of the present invention.

The communication interface 43 is configured to communicate with the neighbor D2D communication module according to the ID of the D2D communication module in this embodiment and routing information maintained by the processor 41.

The processor 41 and the communication interface 43 of the D2D communication module in this embodiment may cooperate with each other to achieve other functions of the D2D communication modules in the embodiments given in the FIG. 1 and FIG. 2, which will not be repeated here.

Alternatively, in a detailed implementation, if the processor 41, the memory 42 and the communication interface 43 are implemented individually, the processor 41, the memory 42 and the communication interface 43 may connect with each other via a bus 44 and achieve communication with each. The bus 44 may be an industry standard architecture (hereinafter referred to as ISA) bus, a peripheral component (hereinafter referred to as PCI) bus or an extended industry standard architecture (hereinafter referred to as EISA) bus and so on. The bus 44 may be classified into an address bus, a data bus, and a control bus. For describing conveniently, only a thick line is displayed in FIG. 4. However, it does not mean only one bus or one type of bus.

Alternatively, in a detailed implementation, if the processor 41, the memory 42 and the communication interface 43 are implemented by integrating on one chip, the processor 41, the memory 42 and the communication interface 43 can achieve the communication with each other via an internal interface.

In this embodiment, each terminal device is set with a D2D communication module. Specifically, each D2D communication module generates an ID of a D2D communication module via a processor of the D2D communication module itself, discovers a neighbor D2D communication module and maintains routing information with the neighbor D2D communication module, and the communication interface performs communication with the neighbor D2D communication module according to the ID of the D2D communication module and the routing information maintained by the processor, thereby realizing the D2D communication between terminal devices.

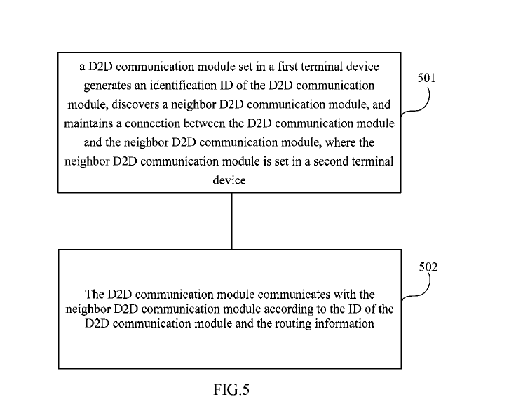

FIG. 5 is a flowchart of a D2D communication method according to embodiments of the present invention. The method of this embodiment can be achieved by the D2D communication module provided in the above embodiment. As shown in FIG. 5, the method of this embodiment includes:

Step 501, a D2D communication module set in a first terminal device generates an identification ID of the D2D communication module, discovers a neighbor D2D communication module, and maintains a connection between the D2D communication module and the neighbor D2D communication module, where the neighbor D2D communication module is set in a second terminal device; and

Step 502, the D2D communication module communicates with the neighbor D2D communication module according to the ID of the D2D communication module and the routing information.

In an alternative implementation, an implementation procedure of step 502 includes: the D2D communication module receives first network data provided by the first terminal device, and transmits the first network data to the neighbor D2D communication module according to the ID of the D2D communication module and the routing information.

Specifically, the D2D communication module receives the first network data provided by a first application program on the first terminal device; the D2D communication module allocates a port to the first application program, packages the first network data to obtain a data packet according to the ID of the D2D communication module, a port number of the first port, an ID of the neighbor D2D communication module and a port number of a second port allocated to a second application program by the neighbor D2D communication module, and transmits the data packet to the neighbor D2D communication module through the routing information, where the second application program is an application program which is on the second terminal device and communicates with the first application program. Alternatively, the D2D communication module may receive the first network data directly downloaded from a network server by the first application program on the first terminal device.

In an alternative implementation, another implementation procedure of step 502 includes: the D2D communication module receives second network data transmitted by the neighbor D2D communication module according to the ID of the D2D communication module and the routing information.

In an alternative implementation, the D2D communication method in this embodiment further includes: the D2D communication module receives the first network data provided by the first terminal device, and stores the first network data into a public cache database.

Based on this, the D2D communication method in this embodiment further includes: the D2D communication module receives a first query request for querying for third network data transmitted by the first application program on the first terminal device, performing a query according to the first query request and returning a first query result to the first application program, where the first query request includes identification information of the third network data.

Further, the performing a query, by the D2D communication module, according to the first search request and returning a first query result to the first application program, includes:

The D2D communication module performs a local query according to the identification information of the third network data; if the third network data is obtained through the local query, the D2D communication module takes the third network data as the first query result and returns to the first application program; and if the third network data is not obtained through the local query, the D2D communication module queries the maintained network data table according to identification information of the third network data, if there is a neighbor index table including the identification information of the third network data, takes the ID of a first neighbor D2D communication module, which corresponds to the neighbor index table including the identification information of the third network data, as the first result and return to the first application program, where, identification information of network data stored in the neighbor D2D communication module is stored in the neighbor index table.

Based on the above, another implementation of step 502 process includes: the D2D communication module receives a second query request transmitted by the first application program; where the second query request is generated by the first application program according to the ID of the first neighbor D2D communication module when the first query result is the ID of the first neighbor D2D communication module, and the second query request includes the ID of the D2D communication module, a port number of a first port allocated to the first application program by the D2D communication module, the ID of the first neighbor D2D communication module, a port number of a third port allocated to a public cache database on the first neighbor D2D communication module by the first neighbor D2D communication module, and identification information of the third network data; the D2D communication module, transmits the second query request to the first neighbor D2D communication module according to the ID of the D2D communication module and the routing information, and receiving the second query result returned by the first D2D communication module according to the second query request; the D2D communication module returns the second query result to the first application program.

In an alternative implementation, another implementation procedure of step 502 includes: the D2D communication module receives a third query request transmitted by the neighbor D2D communication module, according to the ID of the D2D communication module and the routing information, where the third query request includes the ID of the D2D communication module, a port number of a fourth port allocated to the public cache database by the D2D communication module, the ID of the neighbor D2D communication module, a port number of a fifth port allocated to a third application program on the second terminal device by the neighbor D2D communication module, and identification information of fourth network data which is requested to be queried for by the third application; the D2D communication module performs a local query according to the third query request, and return the third query result to the neighbor D2D communication module.

As can be seen from the above, in this embodiment, each terminal device is set with D2D communication module. Specifically, each D2D communication module generates the ID of the D2D communication module through its own routing support unit, discovers the neighbor D2D communication module and maintaining routing information with the neighbor D2D communication module, the point-to-point communication unit performs the communication with the neighbor D2D communication module according to the ID of D2D communication module itself and the routing information maintained by routing support unit, thereby achieving the D2D communication between terminal devices. Furthermore, in this embodiment, data sharing can be realized among terminal devices through the set D2D communication module, if a joint transmission is performed with a cellular communication, the burden of the cellular communication is greatly reduced, and cost of users experience and internet surfing will also be greatly reduced. Furthermore, in this embodiment, it is only required to deploy a D2D communication module in a terminal device without modifying the existing wireless communication systems, which is easy to achieve and have a relative lower deployment cost.

Those skilled in the art can understand that: the steps for achieving the methods of the embodiments, partial or all of them, can be completed using a program relating hardware. The aforementioned program is stored in a readable storage medium of a computer. When executing the program, the steps including the above method of the embodiment are executed; the aforementioned storage medium includes: a media that can store program code, such as an ROM, an RAM, a magnetic disk or an optical disk.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some or all of the technical features; however, these modifications or replacements do not make the essence of corresponding technical solutions depart from the scope of the technical solutions in the embodiments of the present invention.

1. A device-to-device (D2D) communication module included in a first terminal device, the D2D communication module comprising:
a routing support unit, configured to generate an identification (ID) of the D2D communication module, discover a neighbor D2D communication module, obtain routing information with the neighbor D2D communication module, and establish a communication link between the D2D communication module and the neighbor D2D communication module according to the routing information, wherein the neighbor D2D communication module is included in a second terminal device; and
a point-to-point communication unit, configured to communicate with the neighbor D2D communication module according to the ID of the D2D communication module and the communication link.

2. The D2D communication module according to claim 1, wherein the point-to-point communication unit is further configured to:
obtain first network data provided by the first terminal device, and
transmit the first network data to the neighbor D2D communication module according to the ID of the D2D communication module and the communication link.

3. The D2D communication module according to claim 2, wherein
the routing support unit is further configured to obtain an ID of the neighbor D2D module and a port number of an air interface; and
the point-to-point communication unit is further configured to:
receive the first network data provided by a first application program on the first terminal device,
allocate a first port to the first application program,
package the first network data to obtain a data packet according to the ID of the D2D communication module, a port number of the first port, the ID of the neighbor D2D communication module, and a port number of a second port allocated to a second application program by the neighbor D2D communication module, and
transmit the data packet to the neighbor D2D communication module via the communication link, wherein the second application program is an application program that is on the second terminal device and communicates with the first application program.

4. The D2D communication module according to claim 1, wherein the point-to-point communication unit is further configured to receive second network data transmitted by the neighbor D2D communication module according to the ID of the D2D communication module and the routing information.

5. The D2D communication module according to claim 1, further comprising:
a public cache database unit, configured to obtain first network data provided by the first terminal device, and being capable of transmitting the first network data to the neighbor D2D communication unit via the point-to-point communication unit.

6. The D2D communication module according to claim 5, wherein the public cache database unit is further configured to:
receive a first query request for querying for third network data transmitted by a first application program on the first terminal device,
perform a query according to the first query request, and
return a first query result to the first application program, wherein the first query request includes identification information of the third network data.

7. The D2D communication module according claim 6, wherein the public cache database unit is further configured to:
receive the first query request for querying for the third network data transmitted by the first application program,
perform a local query according to the identification information of the third network data,
if the third network data is obtained through the local query, take the third network data as the first query result and return to the first application program, and if the third network data is not obtained through the local query, query a maintained neighbor index table according to the identification information of the third network data,
if there is a neighbor index table including the identification information of the third network data, take an ID of a first neighbor D2D communication module, which corresponds to the neighbor index table including the identification information of the third network data, as the first query result and return to the first application program, wherein the identification information of network data stored in the neighbor D2D communication module is stored in the neighbor index table.

8. The D2D communication module according to claim 7, wherein the point-to-point communication unit is further configured to:
receive a second query request transmitted by the first application program,
transmit the second query request to the first neighbor D2D communication module according to the ID of the D2D communication module and the routing information, and
receive a second query result returned by the first neighbor D2D communication module according to the second query request, and then return the second query result to the first application program;
wherein the second query request is generated by the first application program according to the ID of the first neighbor D2D communication module when the first query result is the ID of the first neighbor D2D communication module,
wherein the second query request comprises the ID of the D2D communication module, a port number of a first port allocated to the first application program by the point-to-point communication unit, the ID of the first neighbor D2D communication module, a port number of a third port allocated to a public cache database in the first neighbor D2D communication module by a point-to-point communication unit in the first neighbor D2D communication module, and identification information of the third network data.

9. The D2D communication module according to claim 5, wherein:
the point-to-point communication unit is further configured to:
receive a third query request transmitted by the neighbor D2D communication module according to the ID of the D2D communication module and the routing information, and
return a third query result to the neighbor D2D communication module,
wherein the third query request comprises the ID of the D2D communication module, a port number of a fourth port allocated to the public cache database by the point-to-point communication unit, an ID of the neighbor D2D communication module, a port number of a fifth port allocated to a third application program on the second terminal device by the point-to-point communication unit in the neighbor D2D communication module, and identification information of fourth network data which is requested to be queried for by the third application program; and
the public cache database unit is further configured to:
receive the third query request transmitted by the point-to-point communication unit,
perform a local query according to the third query request, and
return the third query result to the point-to-point communication unit.

10. The D2D communication module according to claim 3, wherein the point-to-point communication unit is further configured to:
receive the first network data directly downloaded from a network server by the first application program,
allocate the first port to the first application program, package the first network data to obtain the data packet according to the ID of the D2D communication module, the port number of the first port, the ID of the neighbor D2D communication module, and the port number of the second port allocated to the second application program by the neighbor D2D communication module, and
transmit the data packet to the neighbor D2D communication module through the routing information, wherein the second application program is the application program that is on the second terminal device and communicates with the first application program.

11. A device-to-device (D2D) communication method, comprising:
generating, by a D2D communication module set in a first terminal device, an identification (ID) of the D2D communication module;
discovering, by the D2D communication module, a neighbor D2D communication module, establishing a link with the neighbor D2D communication module, and maintaining routing information between the D2D communication module and the neighbor D2D communication module, wherein the neighbor D2D communication module is set in a second terminal device; and
communicating, by the D2D communication module, with the neighbor D2D communication module according to the ID of the D2D communication module and the routing information.

12. The D2D communication method according to claim 11, wherein the communicating, by the D2D communication module, with the neighbor D2D communication module according to the ID of the D2D communication module and the routing information comprises:
obtaining, by the D2D communication module, first network data provided by the first terminal device, and
transmitting the first network data to the neighbor D2D communication module according to the ID of the D2D communication module and the routing information.

13. The D2D communication method according to claim 12, wherein the obtaining, by the D2D communication module, the first network data provided by the first terminal device, and transmitting the first network data to the neighbor D2D communication module according to the ID of the D2D communication module and the routing information comprises:
obtaining, by the D2D communication module, the first network data provided by the first application program on the first terminal device;
allocating, by the D2D communication module, a first port to the first application program, packaging the first network data to obtain a data packet according to the ID of the D2D communication module, a port number of the first port, an ID of the neighbor D2D communication module, and a port number of a second port allocated to a second application program by the neighbor D2D communication module, and transmitting the data packet to the neighbor D2D communication module through the routing information, wherein the second application program is an application program which is on the second terminal device and communicates with the first application program.

14. The D2D communication method according to claim 12, wherein the communicating, by the D2D communication module, with the neighbor D2D communication module according to the ID of the D2D communication module and the routing information comprises:
receiving, by the D2D communication module, second network data transmitted by the neighbor D2D communication module according to the ID of the D2D communication module and the routing information.

15. The D2D communication method according to claim 11, further comprising:
obtaining, by the D2D communication module, first network data provided by the first terminal device, and
storing the first network data into a public cache database.

16. The D2D communication method according to claim 15, further comprising:
receiving, by the D2D communication module, a first query request for querying for third network data transmitted by a first application program on the first terminal device,
performing a query according to the first query request, and
returning a first query result to the first application program, wherein the first query request comprises identification information of the third network data.

17. The D2D communication method according to claim 16, wherein the performing the query according to the first query request and returning the first query result to the first application program comprises:
performing, by the D2D communication module, a local query according to the identification information of the third network data;
if the third network data is obtained through the local query, taking, by the D2D communication module, the third network data as the first query result and returning to the first application; and
if the third network data is not obtained through the local query, querying, by the D2D communication module, a maintained neighbor index table according to the identification information of the third network data, and if there is a neighbor index table including the identification information of the third network data, taking an ID of a first neighbor D2D communication module, which corresponds to the neighbor index table including the identification information of the third network data, as the first query result and returning to the first application program, wherein identification information of network data stored in the neighbor D2D communication module is stored in the neighbor index table.

18. The D2D communication method according to claim 17, wherein the communicating, by the D2D communication module, with the neighbor D2D communication module according to the ID of the D2D communication module and the routing information comprises:
receiving, by the D2D communication module, a second query request transmitted by the first application program; wherein the second query request is generated by the first application program according to the ID of the first neighbor D2D communication module when the first query result is the ID of the first neighbor D2D communication module, and the second query request comprises the ID of the D2D communication module, a port number of a first port allocated to the first application program by the D2D communication module, an ID of the first neighbor D2D communication module, a port number of a third port allocated to a public cache database on the first neighbor D2D communication module by the first neighbor D2D communication module, and identification information of the third network data;
transmitting, by the D2D communication module, the second query request to the first neighbor D2D communication module according to the ID of the D2D communication module and the routing information, and receiving a second query result returned by the first neighbor D2D communication module according to the second query request; and
returning, by the D2D communication module, the second query result to the first application program.

19. The D2D communication method according to claim 15, wherein the communicating, by the D2D communication module, with the neighbor D2D communication module according to the ID of the D2D communication module and the routing information comprises:
receiving, by the D2D communication module, a third query request transmitted by the neighbor D2D communication module according to the ID of the D2D communication module and the routing information, wherein the third query request comprises the ID of the D2D communication module, a port number of a fourth port allocated to the public cache database by the D2D communication module, an ID of the neighbor D2D communication module, a port number of a fifth port allocated to a third application program on the second terminal device by the neighbor D2D communication module, and identification information of fourth network data which is requested to be queried for by the third application program;
performing, by the D2D communication module, a local query according to the third query request, and returning the third query result to the neighbor D2D communication module.

20. The D2D communication method according to claim 13, wherein the receiving, by the D2D communication module, the first network data provided by the first application program on the first terminal device comprises:
receiving, by the D2D communication module, the first network data directly downloaded from a network server by the first application.

21. A terminal device, comprising:
a device-to-device D2D communication module according to claim 1; and
at least one D2D air interface;
wherein the D2D communication module is configured to communicate with a neighbor D2D communication module via the at least one D2D air interface.
